(19) United States
(12) Patent Application Publication
(10) Pub. No.: US 2016/0191582 A1
(43) Pub. Date: Jun. 30, 2016

(54) Method for Facilitating Live Stream Feeds of Remote Locations, Events or Products, in a Social, Virtual Travel, or Business Setting

(71) Applicant: Krishna Shivaram, Torrance, CA (US)

(72) Inventor: Krishna Shivaram, Torrance, CA (US)

(21) Appl. No.: 15/060,948

(22) Filed: Mar. 4, 2016

Related U.S. Application Data
(63) Continuation of application No. 14/641,029, filed on Mar. 6, 2015.
(60) Provisional application No. 61/949,892, filed on Mar. 7, 2014.

(51) Int. Cl. H04L 29/06; H04L 12/14; H04N 21/472; G06Q 30/04; G06Q 10/10; H04N 21/2187

(52) U.S. Cl. CPC H04L 65/4069; G06Q 10/1095; H04N 21/2187; H04N 21/472; G06Q 30/04; H04L 12/1439

(57) ABSTRACT

A method for facilitating live feed streams of remote locations by communicably connecting a first electronic streaming device to a second electronic streaming device through a back-end system. A client user account is operated on the first electronic streaming device, while a streaming account is operated on the second electronic streaming device. Tour information is submitted through the client user account, wherein a tour request is made and an event appointment is scheduled between the client user account and the streaming account. At the time of the event appointment, the client user account is communicably connected to the streaming account through the first electronic streaming device and the second electronic streaming device. A live stream video feed is then transmitted from the streaming account to the client user account, wherein the live stream video feed is viewed on the first electronic streaming device.

The current application is a continuation in part of U.S. Utility patent application Ser. No. 14/641,029 filed Mar. 6, 2015 which claims benefit of the U.S. Provisional Patent application Ser. No. 61/949,892 filed on Mar. 7, 2014.

### FIELD OF THE INVENTION

The present invention relates generally to providing live streams of remote locations, businesses, and social events. More specifically, the present invention is a system and method for electronic tourism that provides an improved customer experience and more secure payment methods.

### BACKGROUND OF THE INVENTION

While the concept is known to many, vacation time is not something which is available to all persons. Even amongst those who have vacation time, they may find it financially or even physically unfeasible to take a trip to a location of interest. The present invention, rather than bring the person to the location, brings the location to the person. Using the internet and audio-visual technology, a vacation experience is simulated and transmitted to a client user, allowing them to travel the world without leaving their living room.

The present invention provides a platform that connects users from across the world, allowing a client user to receive a live stream of a tour of a desired location. In this manner the present invention can substitute for a physical vacation or even aid with preparation and planning for a physical vacation. The present invention also applies improvements that build upon social media and payment processes that ultimately enhance electronic tourism. As an end result, the present invention is able to improve customer satisfaction and better obtain and retain an active user community.

A number of solutions have been attempted by others; a common example is a pre-recorded DVD or internet video that addresses an interesting location. However, these videos are often pre-planned and intended to attract tourists or enhance an area's reputation, further distorted by actions such as post-processing. Though some systems have been developed to overcome this by providing streaming tours, they do not provide the numerous advancements and benefits across a number of areas as provided by the present invention.

It is noted that the present invention was independently conceptualized and developed by the inventor; the creation was in no way influenced by prior art.

### BRIEF DESCRIPTION OF THE DRAWINGS

FIG. 1 is a diagram depicting the first electronic device being communicably connected to the second electronic streaming device through a back-end system.

FIG. 2 is a flowchart depicting the steps for carrying out a virtual tour between a client user account and a streaming account.

FIG. 3 is a flowchart thereof, further depicting steps for selecting the streaming account after a tour request has been processed for the real-time streaming event.

FIG. 4 is a flowchart thereof, further depicting steps for displaying the tour request in a tour requests list for the client user account.

FIG. 5 is a flowchart thereof, further depicting steps for displaying the tour request in an applied tours list for each of the streaming accounts.

FIG. 6 is a flowchart thereof, further depicting steps for providing the client user with a plurality of recommended streaming accounts for desired locations on a destination wish list.

FIG. 7 is a flowchart thereof, further depicting steps for searching for a streaming account prior to submitting a tour request.

FIG. 8 is flowchart thereof, further depicting steps for selecting the streaming account through a third-party website.

FIG. 9 is a flowchart thereof, further depicting steps for adding the event appointment to an events calendar for both the client user account and the streaming account.

FIG. 10 is a flowchart thereof, further depicting steps for generating an events page and managing the attendance of invited guests.

FIG. 11 is a flowchart thereof, further depicting steps for adding location data for the real-time streaming event to an interactive map of the client user account.

FIG. 12 is a flowchart thereof, further depicting steps for requesting a tour for an upcoming event listed on the profile page of a streaming account.

FIG. 13 is a flowchart thereof, further depicting steps for requesting a tour for a showcase item listed on the profile page of a streaming account.

### DETAIL DESCRIPTIONS OF THE INVENTION

All illustrations of the drawings are for the purpose of describing selected versions of the present invention and are not intended to limit the scope of the present invention.

The present invention is a method for facilitating live stream feeds of remote locations. Through the implementation of the present invention, a user is able to visually and aurally experience foreign locations under the direction of a service-providing entity or subsequent user. While a distinction is made between client users and service-providing entities, client users may also act as service-providing entities; this allows client users of the present invention to provide guided tours in addition to contracting tours from professional service-providing entities and subsequent client users.

The primary benefit of the present invention is the ability for a client user to become an “e-Traveler” (which can also be referred to as an “e-Hopper” or “eHopper”); the present invention defines this as a person who experiences a remote location by receiving video and/or audio streams from a location of interest. The ability to become an e-Traveler is beneficial in a number of situations for varying reasons. For example, the client user may wish to visit the pyramids of Egypt but be unable to do so due to poor health or insufficient funds to pay for the necessary travel and lodging. In another situation, the client user may be planning a vacation to Paris and desires to simulate the experience in order to prepare a better itinerary.

The present invention is also particularly beneficial in the fields of real estate, to both real-estate agents and potential buyers. Typical property sales require an individual to visit the physical location in order to inspect the property. Using the present invention, potential buyers can virtually tour the property before visiting in person or making an offer. This is especially valuable to potential buyers who live far away or even out-of-state, as it saves time and cuts down on travel expenses. The present invention also allows a real-estate agent to show a property to a wider audience, and to save time by giving a single tour for multiple people. The concept can also be extended to viewing or showcasing assisted living facilities, memory care facilities, senior living facilities, etc.

The present invention is also beneficial for property owners and property management, as the present invention allows a property manager or contractor to remotely show the property owner maintenance and construction issues before and after repairs or renovations are made. The present invention could also be useful for plumbers, electricians, or other handymen. The present invention can be used for remote business applications other than real-estate and property management, such as viewing or showcasing products such as cars, jewelry, artwork, specialty clothing, bridal gowns, etc.

In yet another scenario, the client user may be unable to physically attend a special event (e.g. a wedding, birthday, graduation, engagement, or anniversary) for a subsequent user due to insufficient funds or for health reasons. In such situations the present invention can be used to view travel or event locations, such as hotels, resorts, restaurants, banquet halls, temples, wedding chapels, funeral homes, etc. Client users may utilize the present invention for any purpose; the present invention is not limited to use in the aforementioned scenarios. Through the present invention, the client user can choose from multiple streaming sources and create a schedule of events to stream. In order to do so, the client user must first establish a client user account that is used to remotely connect to a streaming account. The streaming account is associated with either a subsequent client user or service-providing entity and as such, the streaming account may more specifically be a subsequent client user account or a service provider account. The client user can create the client user account through a host software that is communicably coupled to a back-end system that is also used to store information relevant to the operation of the present invention. The back-end system can be any type of networking equipment, such as servers, routers, etc. In the preferred embodiment of the present invention, the host software is implemented as a website that is directly hosted on the back-end system. Alternatively, the host software may be a downloadable application that can be connected to the back-end system via the internet.

In order to establish the client user account, the client user must complete a registration process through the host software. During the registration process, the client user provides personal information that is submitted through the host software and stored on the back-end system. The personal information may include, but is not limited to, the name of the client user, a username, a password, email address, or payment information. Through account settings for the client user account, the client user can determine which information is displayed to other users of the host software. For example, the client user may be provided the option to display their name, initials, username, or a nickname to other users that are non-friends.

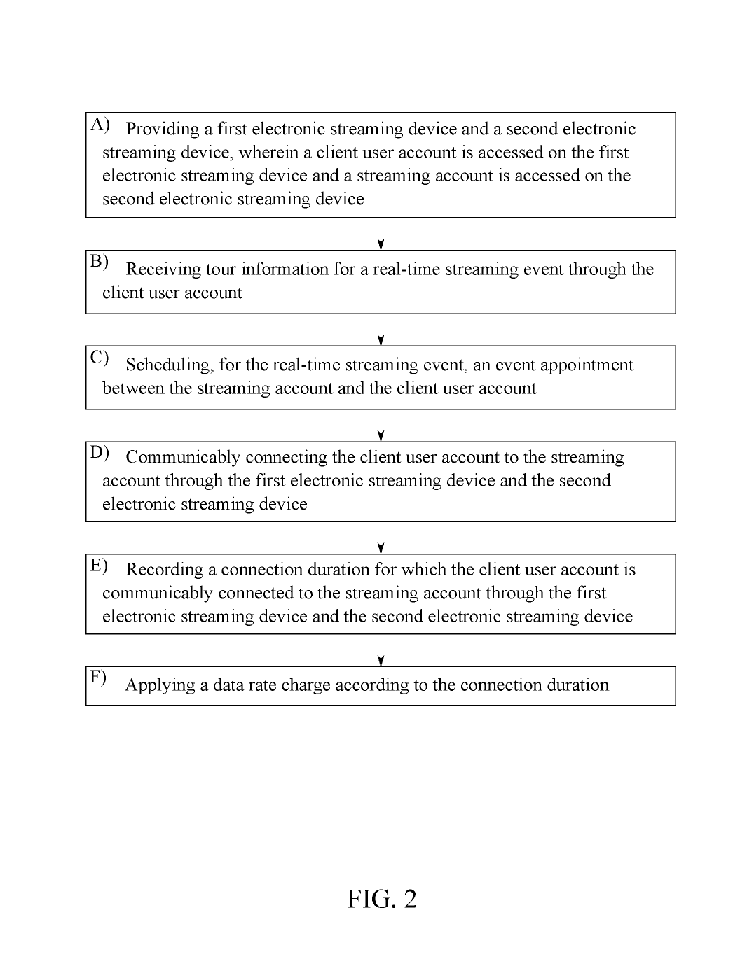

Once the client user has established the client user account, the client user is provided access to the functions of the present invention through the host software. The primary function of the present invention is to allow the client user to view remote locations through a live stream video feed. In reference to FIG. 2, the client user can request a real-time streaming event by providing tour information for the real-time streaming event. The present invention provides a request a tour module for the client user account through which the tour information is submitted to the back-end system. As such, the request a tour module provides a plurality of input fields displayed through the client user account, wherein each of the plurality of input fields is specialized to ascertain information used to specify the type of event that the client user is requesting. The tour information that is entered into the plurality of input fields may include, but is not limited to, a price range, a tour location, special sight requests, an event duration, the type of business, a tour date, a time zone for coordinating schedules, the number of people watching, the number of different devices connecting, a language preference, and a message to the streaming account.

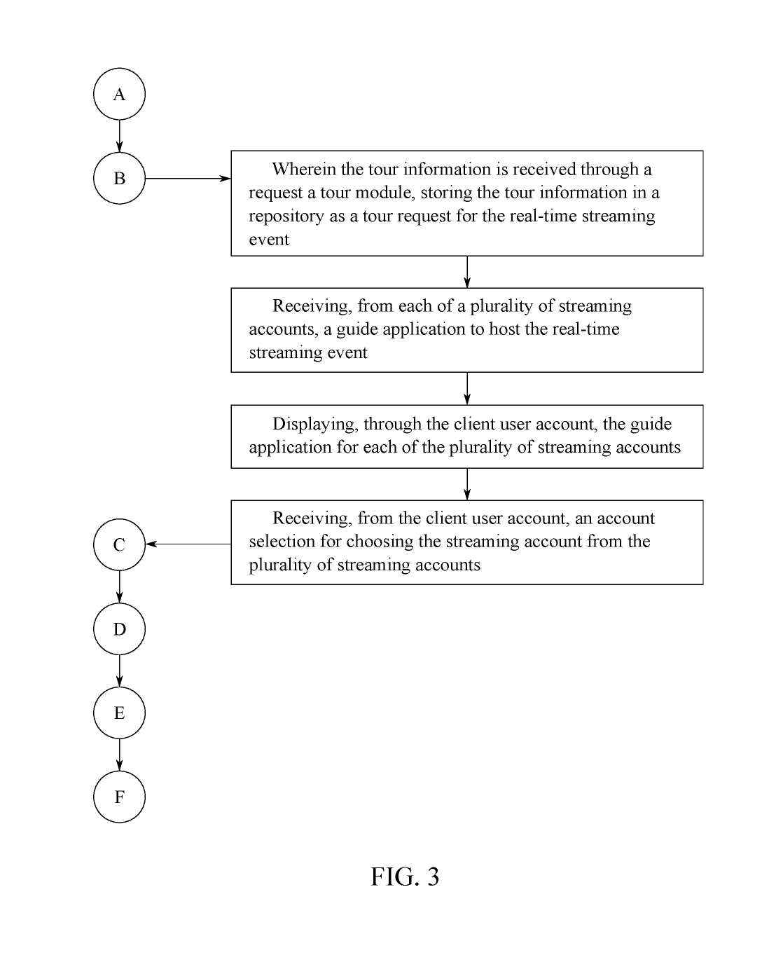

In reference to FIG. 3, the back-end system receives the tour information submitted through the client user account and stores the tour information in a repository as a tour request for the real-time streaming event. The back-end system then directs the tour request to the appropriate service-providing entities within the region of the event. Each of the service-providing entities in the region can then offer their services to the client user, wherein the client user can select the service-providing entity of their choice. The client user can select the service-providing entity based on cost, service rating, etc., or a combination of any factors. For example, if the client user requests a tour for a certain location, the client user may receive responses from multiple tour guides, wherein the client user can select the best tour guide based on cost, service rating, and tourist sites visited.

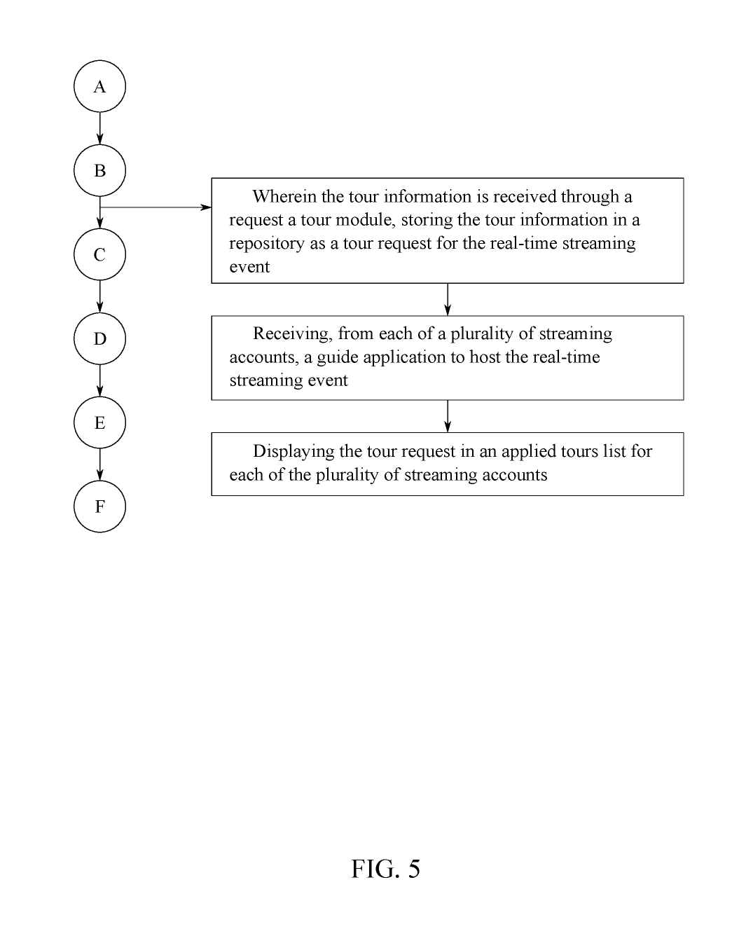

More specifically, the back-end system directs the tour request to a plurality of streaming accounts, wherein each of the plurality of streaming accounts is for a unique service-providing entity. Upon receiving the tour request, the unique service providing entity can decide whether or not to offer service to the client user. In order to offer service, the unique service providing entity must complete a guide application for the real-time streaming event. The guide application can include information such as hourly rate, available dates, tour specialties, previous tours, etc. In reference to FIG. 5, the back-end system receives the guide application from each of the plurality of streaming accounts that would like to offer service to the client user, and displays the tour request in an applied tours list for each of the plurality of streaming accounts. The applied tours list provides a log of all of the tour requests to which the unique service providing entity has submitted a guide application, such that the unique service providing entity can easily search through all potential streaming events.

In reference to FIG. 3, upon receiving the guide application for each of the plurality of streaming accounts, the back-end system displays the guide application for each of the plurality of streaming accounts through the client user account. The client user can then select the streaming account from the plurality of streaming accounts that is most desirable. To choose the streaming account from the plurality of streaming accounts, the client user makes an account selection through the client user account. The back-end system receives the account selection from the client user account and then proceeds to schedule an event appointment between the client user account and the streaming account, for the real-time streaming event, as depicted in FIG. 2. The client user and the unique service providing entity can then further communicate if necessary via the client user account and the streaming account respectively.

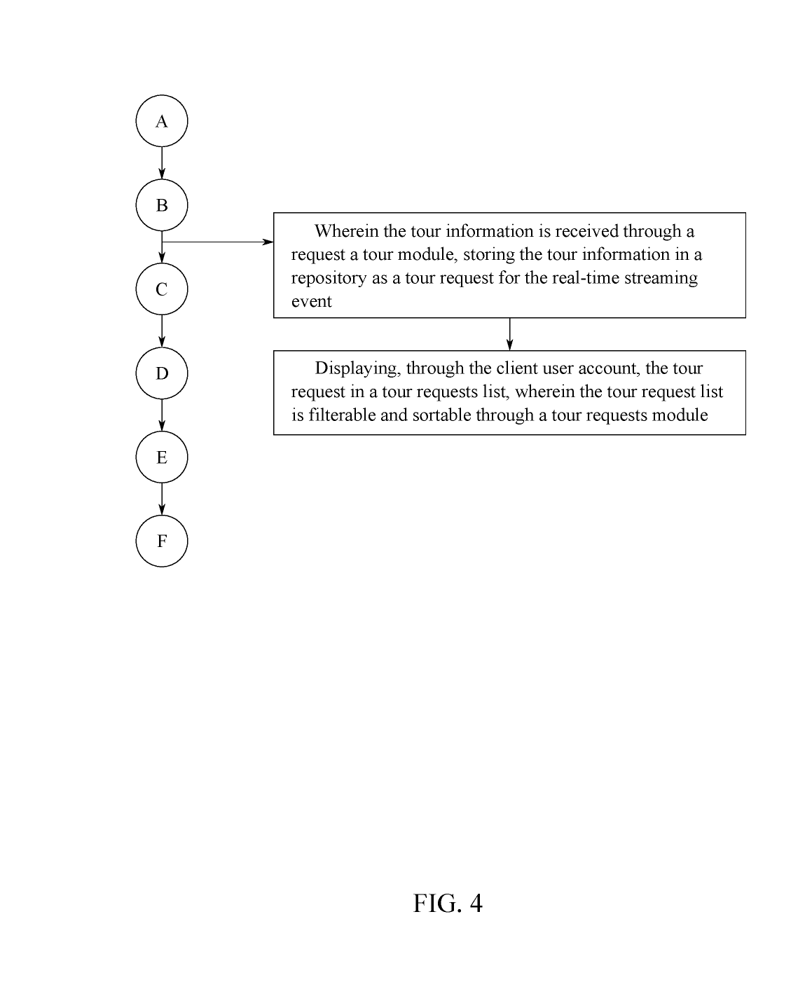

Similar to the applied tours list for each of the plurality of streaming accounts, a tour requests list is provided for the client user account. In reference to FIG. 4, the tour request is displayed through the client user account in the tour request list along with any other tours that the client user has requested or completed. The tour request list is displayed through a tour requests module, wherein the tour request list is sortable and filterable through the tour requests module. The tour requests modules allows the client user to sort the tour request list by newest event, oldest event, tour date, recent activity, etc. Additionally, the tour request list can be filtered according to the status of each event on the tour request list. Statuses for each event can include, but are not limited to, pending events, events that have been paid for, completed events, and reviewed events. By clicking the tour request within the tour request list, the tour request is expanded to show more detailed information in regards to the real-time streaming event.

Furthermore, the tour requests module provides a scroll bar that displays the recent or upcoming tour requests. The tour requests within the scroll bar are color coded according to the type of event. For example, birthday parties, or similar gatherings, could be colored green, while tours could be colored red. Furthermore, each of the tour requests displayed in the scroll bar shows basic information in regards to the real-time streaming event. In this way, the scroll bar provides the client user with a quick overview of the tour requests that have occurred or will occur within a recent time window.

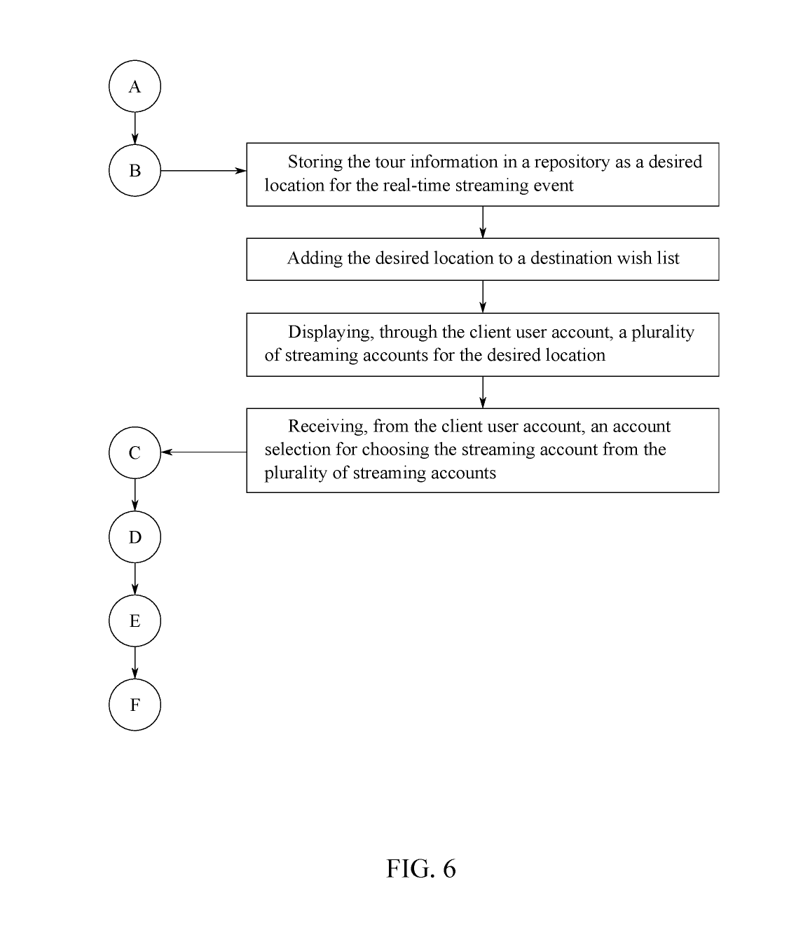

In reference to FIG. 6, the client user is also able to create a destination wish list that includes at least one location to which the client user would like to virtually travel. In order to add a desired location to the destination wish list, the client user enters the tour information through the client user account. The back-end system receives the tour information through the client user account, and stores the tour information in the repository as the desired location for the real-time streaming event. The back-end system then adds the desired location to the destination wish list, wherein the destination wish list is displayed through the client user account.

In further reference to FIG. 6, the present invention also provides guide matches for each of the at least one location on the destination wish list. Using the tour information, the back-end system finds a plurality of streaming accounts for the desired location that could be suitable for the client user. The back-end system then recommends the plurality of streaming accounts to the client user, wherein the back-end system displays the plurality of streaming accounts through the client user account on a guide matches page. When a new location is added to the destination wish list, the guide matches page is updated accordingly.

In yet further reference to FIG. 6, if the client user likes a recommended guide, then the client user can select the streaming account for the recommended guide from the plurality of streaming accounts on the guide matches page. To choose the streaming account from the plurality of streaming accounts, the client user makes the account selection through the client user account by clicking the listing for the recommended guide. The back-end system receives the account selection from the client user account and then proceeds to schedule the event appointment between the client user account and the streaming account, for the real-time streaming event.

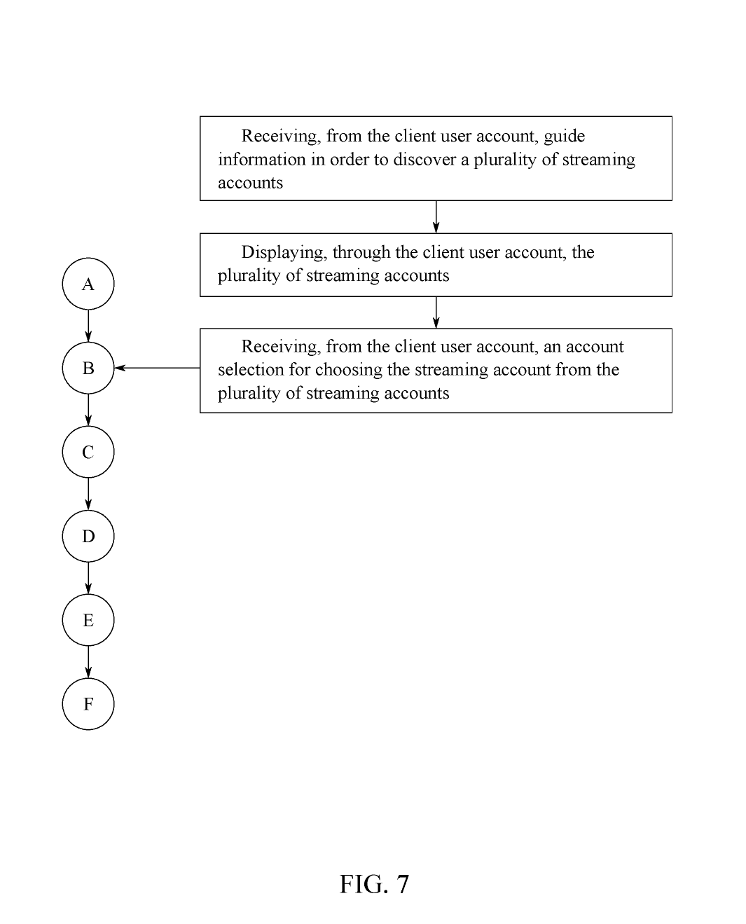

In reference to FIG. 7, the client user can also request a tour by first searching through the plurality of streaming accounts in order to find the desired guide. The back-end system provides a guide search module that is accessible through the client user account, wherein the guide search module provides a plurality of input fields for entering guide information. The guide information can include, but is not limited to, a location, a location radius, a landmark, an account type (e.g. a business, tour guide, subsequent eHopper, etc.), a business type, a language, a feedback rating, and a price rate. The back-end system receives the guide information from the client user account and analyzes the guide information in order to discover a plurality of streaming accounts that best match the requests of the client user within the guide information.

In further reference to FIG. 7, after the back-end system analyzes the guide information, the back-end system displays the plurality of streaming accounts through the client user account, wherein the client user can select the streaming account for the desired guide. To choose the streaming account from the plurality of streaming accounts, the client user makes the account selection through the client user account by clicking the listing for the desired guide. The back-end system receives the account selection from the client user account and then directs the client user to a profile page for the streaming account of the desired guide. Through the profile page of the streaming account, the client user can enter the tour information and directly request a tour with the desired guide. If the desired guide accepts the tour request, then the back-end system proceeds to schedule the event appointment between the client user account and the streaming account, for the real-time streaming event.

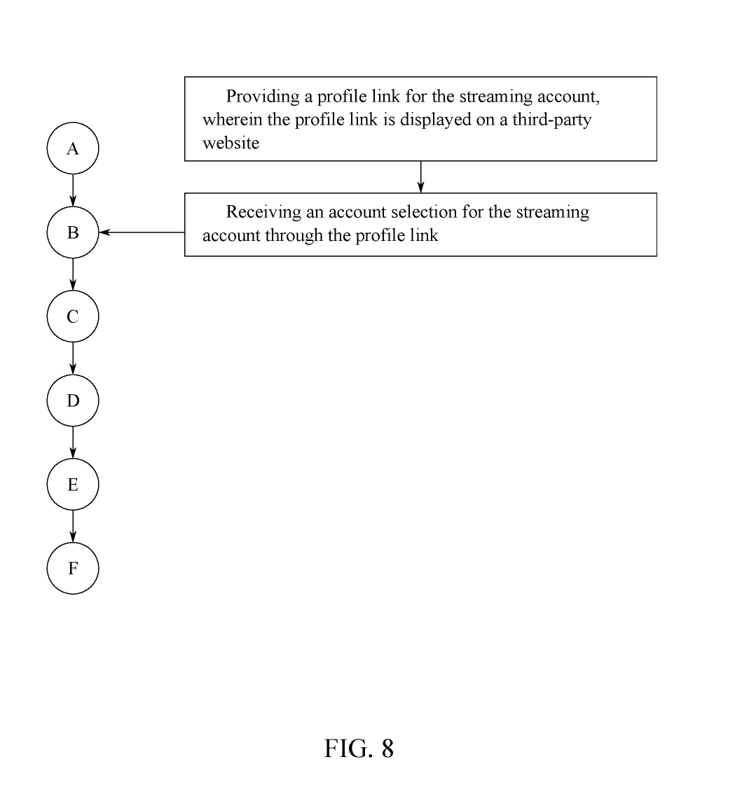

In reference to FIG. 8, in addition to using the guide search module, the client user can also make the account selection for the streaming account using a profile link. The profile link is associated with the streaming account and is displayed on a third-party website of the desired guide or business. When the client user selects the profile link on the third-party website, the client user is directed to the profile page for the streaming account, wherein the account selection for the streaming account is made through the profile link. Through the profile page of the streaming account, the client user can enter the tour information and directly request a tour with the desired guide or business. If the desired guide or business accepts the tour request, then the back-end system proceeds to schedule the event appointment between the client user account and the streaming account, for the real-time streaming event.

The profile page allows the service providing entity of the streaming account to display service provider information, upcoming streaming events, past streaming events, and listings of products, showings, etc. The service provider information can include, but is not limited to, company info (e.g. address, phone number, email address), a company logo, a uniform resource locator, and a company description. If the service providing entity creates the real-time streaming event being a public event, then the real-time streaming event is displayed on the profile page of the streaming account as an upcoming streaming event.

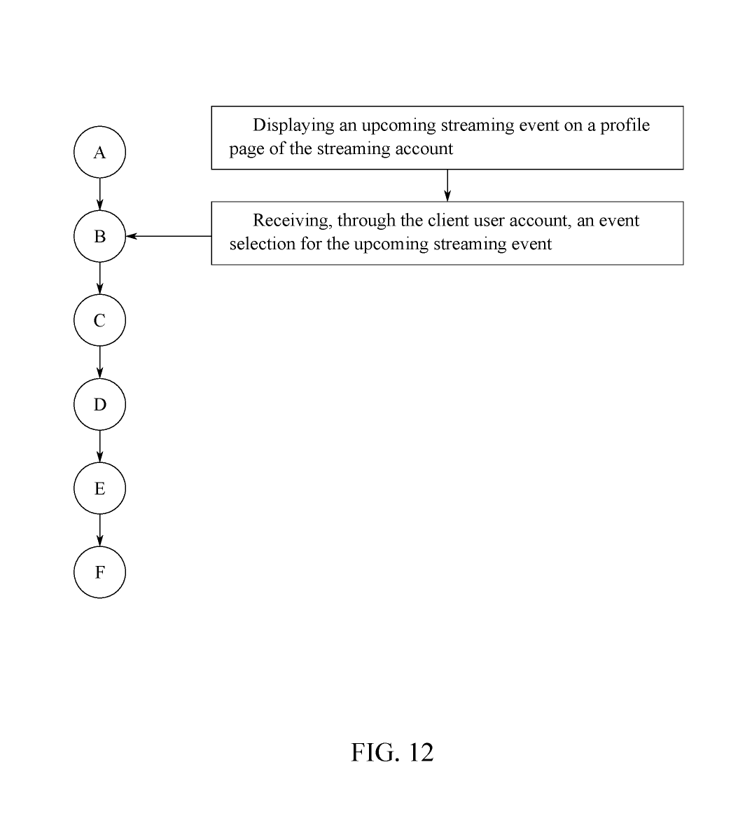

In reference to FIG. 12, if the client user would like to attend the upcoming streaming event, then the client user makes an event selection for the upcoming streaming event through the user account by clicking on the posting for the upcoming streaming event. The event selection also links the tour information for the upcoming streaming event to the client user account. When client user makes the event selection through the client user account, the back-end system receives the tour information for the upcoming event and schedules the event appointment on the events calendar for the client user account.

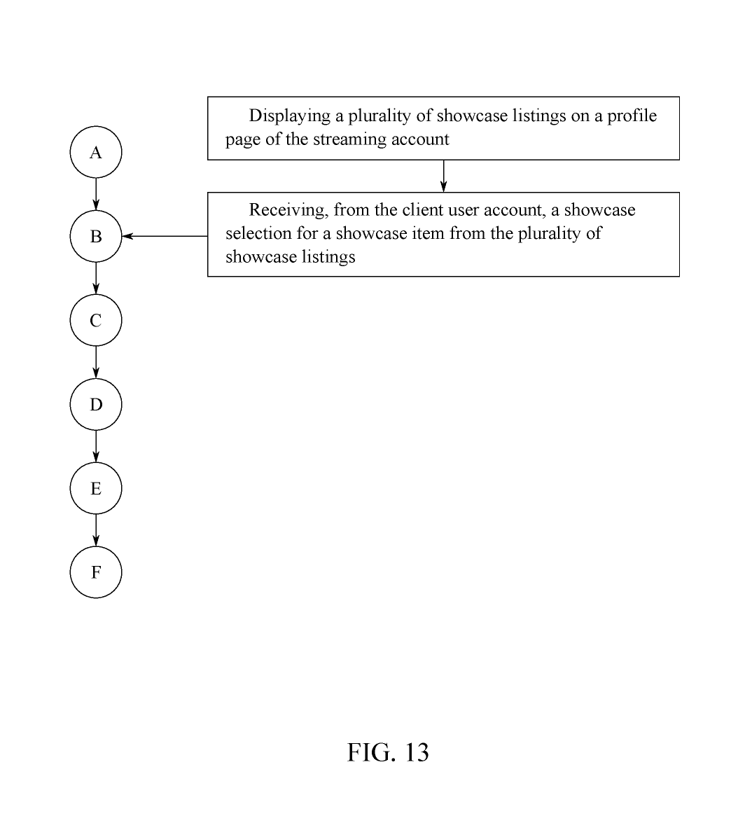

In reference to FIG. 13, the service providing entity can also provide listings of items, products, etc. on the profile page, wherein the client user can select a showcase item for which to request a tour or showing. For example, a realtor may have several properties listed, wherein the client user can request a tour for a specific property, or a jeweler may have several pieces of jewelry, wherein the client user can request a virtual showing of a specific piece of jewelry. A plurality of showcase listings is displayed on the profile page of the streaming account, wherein each of the plurality of showcase listings is for a different item, product, etc. The client user can then make a showcase selection for the showcase item from the plurality of showcase listings. The back-end system receives the showcase selection for the showcase item from the client user account and prompts the client user account to submit the tour information in order to generate the tour request.

The host software also provides a search component that allows the client user to search through a plurality of streaming events, wherein the plurality of streaming events is displayed to the client user through the client user account. The client user can search for events from subsequent client users, such as weddings, birthday parties, etc., as well as events from service providing entities, such as tours, public business meetings, etc. By using the search component the client user can look for a streaming event that matches specific criteria or, provided the client user is flexible, look for more general streaming events that may be of interest.

The present invention provides a number of ways in which the client user is able to search through the plurality of streaming events. One method of searching through the plurality of streaming events is using location data for the event/location to be streamed. The location data can be entered by the client user though input fields, or using an interactive map. Another method of searching through the plurality of streaming events is by category, such as the type of event, languages spoken, user rating, or hourly rate. Yet another method for searching through the plurality of streaming events is by providing a list or lists of the plurality of streaming events. For example, a list of businesses and streaming events can be displayed through a website homepage, or other page, wherein the client user can be directly linked to a streaming event or to a list of streaming events for a particular business. Examples of businesses and events that can be listed include, but are not limited to, hotels and resorts, assisted living, wedding halls and bridal stores, tour guides, photographers, videographers, event planners, jewelers, car showrooms, real estate, weddings, birthday parties, graduations, bar mitzvahs, and sporting events.

By searching through the plurality of streaming events, the client user can make a streaming selection for a specific event. For example, the streaming selection can be for the wedding of a subsequent user, a tour of another country, or to view a public business venture. Once the streaming selection is selected through the client user account, the streaming selection is received by the back-end system. The back-end system then schedules the event appointment between the streaming account associated with the streaming selection and the client user account. If the streaming selection is for an event hosted by a subsequent client user, then the streaming account is the subsequent client user account of the subsequent user account. If the streaming selection is for a business event or a tour, then the streaming account is the service provider account for the service-providing entity.

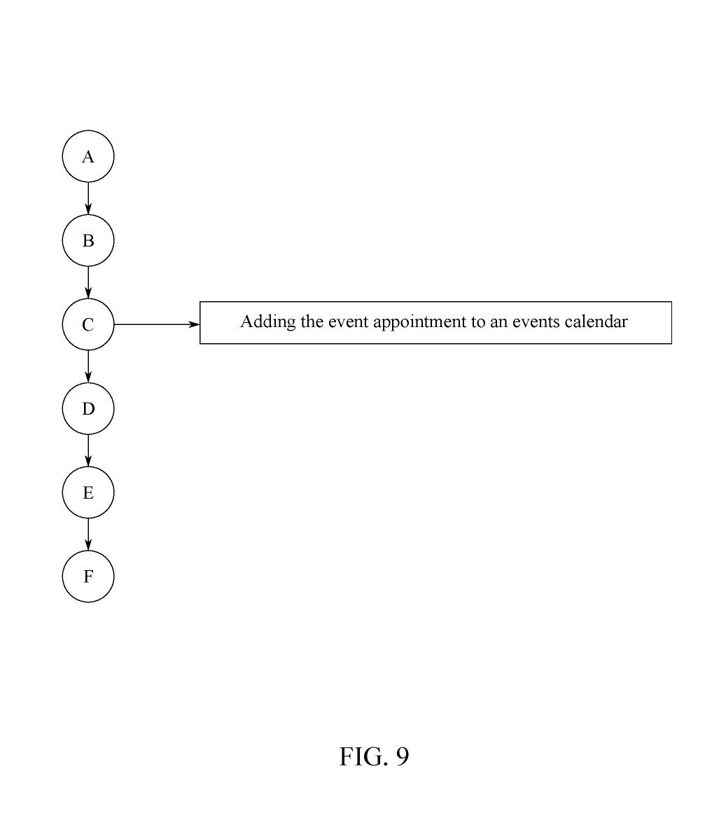

In reference to FIG. 9, as a part of scheduling the event appointment, the back-end system adds the event appointment to an events calendar for the client user account. The event appointment is added to the events calendar at the date and time agreed upon by the client user and the service-providing entity or the subsequent client user. The events calendar visually organizes all of the event appointments for the client user, such that the client user can readily keep track of all appointments with, both service-providing entities and subsequent client users, through the client user account. The events calendar also allows the client user to select the desired streaming event directly from the events calendar and proceed with displaying the live stream video feed for the streaming selection. An events calendar is also provided for the streaming account, such that the operator of the streaming account can keep track of appointments.

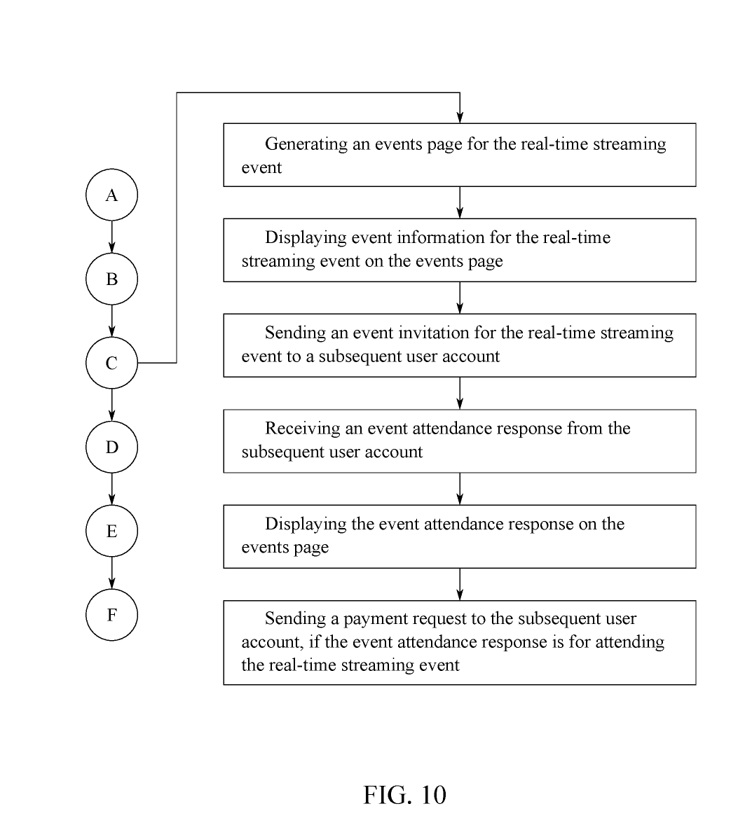

In reference to FIG. 10, the back-end system also generates an events page for the real-time streaming event, wherein event information for the real-time streaming event is displayed on the events page by the back-end system. The event information can include, but is not limited to, location data for the event (e.g. a map, address, or combination thereof), photos, videos, comments, the type of event, the cost of the event, an event description, guests invited to the real-time streaming event, and an attendance status for each of the invited guests. The events page organizes the details of the real-time streaming event in a single location that is accessible to all of the invited guests and the host or guide of the real-time streaming event. The events page allows each of the invited guests to select an attendance status, to designate whether or not each of the invited guests intends on attending the real-time streaming event. In the preferred embodiment of the present invention, the attendance status can be to not attend the real-time streaming event, virtually attend the real-time streaming event, or physically attend the real-time streaming event.

In further reference to FIG. 10, the client user can invite guests to the real-time streaming event by selecting the guests from a contacts list. Once the client user has selected the guests from the contacts list, the back-end system sends an event invitation for the real-time streaming event to a subsequent user account for each of the invited guests. Each of the invited guests can then select and send an event invitation response, wherein the back-end system receives the event invitation response from the subsequent user account of each of the invited guests. Furthermore, the back-end system displays the event attendance response on the events page as the attendance status for each of the invited guests. If needed, the attendance status for each of the invited guests can be updated through the events page.

When other guests are invited to the real-time streaming event, the cost of the real-time streaming event can be split among the client user account and the subsequent user account of each of the invited guests. For example, if the cost of the real-time streaming event is fifty dollars and the client user invites four guests, the client user can elect to pay for the entirety of the real-time streaming event, or the cost may be evenly split between the client user and the four guests, resulting in a cost of ten dollars per person. Details is regards to the cost per person can be updated and displayed through the events page. The cost per person can be updated automatically as the invited guests accept or decline the event invitation, such that everyone attending is aware of the cost through the events page. Additionally, the client user can elect to split the cost evenly or unevenly amongst the invited guests.

The service providing entity can also invite guests to the real-time streaming event by selecting the guests from a followers list. The followers list includes individuals who have subscribed to the streaming account of the service providing entity. Once the service providing entity has selected the guests from the followers list, the back-end system sends the event invitation for the real-time streaming even to the subsequent user account for each of the invited guests. Each of the invited guests can then select and send an event invitation response, wherein the back-end system receives the event invitation response from the subsequent user account of each of the invited guests. The ability for the service providing entity to invite guests to the real-time streaming event is especially beneficial for publicly available streaming events or streaming events specialized for a particular set of followers.

The client user can also request the real-time streaming event from a friend or family member within the contacts list of the client user. Similar to requesting the real-time streaming event from the service providing entity, the client user submits the tour information through the client user account, providing a desired time, location, etc. The back-end system receives the tour information and then generates the tour request, wherein the tour request is then sent to the streaming account of the friend or family member. If the friend or family member accepts the tour request, then the event appointment for the real-time streaming event is scheduled between the client user account and the streaming account of the friend or family member.

An event activation code may also be used in order for the client user account to access the live stream video feed; the event activation code for each streaming event being a unique code. Upon scheduling the event appointment, the back-end system also provides the client user and the operator of the streaming account with the event activation code. The event activation code is then entered through the client user account and the streaming account at the event appointment time in order to communicably connect the client user account and the streaming account. Alternatively, the event activation code could be used only by the back-end system, wherein the event activation code is not distributed to the client user account and the streaming account. In this way, the client user and the service-providing entity only need to select the streaming event from the events calendar, and are automatically connected to one another by the back-end system.

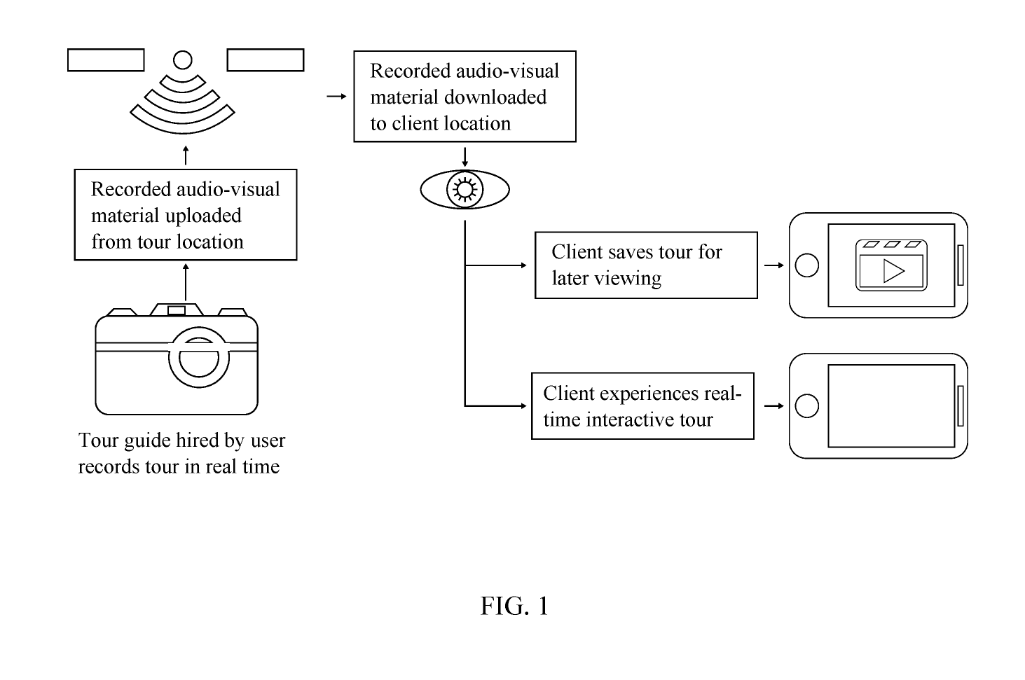

In reference to FIG. 1-2, the client user experiences the streaming event through the live stream video feed that is recorded through the streaming account. In order to accomplish this, the client user operates the client user account through the host software on a first electronic streaming device, wherein the first electronic streaming device provides means for receiving and displaying the live stream video feed. The streaming account is operated through the host software on a second electronic streaming device, wherein the second electronic streaming device provides a means for recording and transmitting the live stream video feed. For example, the first electronic streaming device could be a desktop or laptop computer and the second electronic streaming device could be a smartphone or webcam capable of transmitting video and audio.

In further reference to FIG. 1-2, the back-end system communicably connects the client user account to the streaming account through the first electronic streaming device and the second electronic streaming device, such that the client user can view the live stream video feed of the remote location. The back-end system records a connection duration for which the user account is communicably connected to the streaming account through the first electronic streaming device and the second electronic streaming device. The connection duration is used by the back-end system to apply a data rate charge to the either the client user account or the streaming account. In the preferred embodiment of the present invention, the back-end system only charges the streaming account for the data rate charge.

The data rate charge is applied per unit of time and may be charged at different rates depending on the operator of the streaming account. In the preferred embodiment of the present invention, the first thirty minutes of streaming are free (i.e. the data rate charge is zero) and then the data rate charge is applied at a first rate if the streaming account is the subsequent client user account for a subsequent client user, and at a second rate if the streaming account is the service provider account for a service-providing entity. For example, the streaming account being the subsequent client user account is charged at the first rate of two cents per minute, while the streaming account being the service provider account is charged at the second rate of five cents per minute. In another embodiment of the present invention, the first one hundred minutes of streaming are free.

Ideally, the client user account is communicably connected to the streaming account in real-time. The back-end system receives the live stream video feed through the streaming account on the second electronic streaming device, wherein the back-end system then displays the live stream video feed on the first electronic streaming device through the client user account. This is beneficial for streaming events such as tours, as it allows the client user to directly interact with a tour guide (eGuide) during the tour, such as to ask relevant questions about particular sites or locations. During the real-time streaming of tours, the tour guides may also be permitted to turn off the second electronic streaming device while commuting from one location to another.

Additionally, the client user is allowed to and even encouraged to record the live stream vide feed or take screenshots of interesting landmarks and locations. This helps the client user to feel as if they physically visited the location and took pictures or video footage. The client user enters storage commands through the client user account, such as selecting a time stamped section of the live stream video feed to record, or a particular moment to take a screenshot. The back-end system receives the storage commands for a portion of the live stream video feed through the client user account and then stores said portion of the live stream video feed. The portion of the live stream video feed is then accessible through the client user account to view at a later date.

It is also possible for the live stream video feed to be stored directly on the back-end system in the event that the client account cannot communicably connect to the streaming account in real-time. Similar to storing the portion of the live stream video feed, this allows the entirety of the live stream video feed to be accessible to view through the client user account at a later time. This is essentially the same as connecting to the streaming account in real-time, except that the client user cannot interactive the operator of the streaming account. This variation is beneficial if the client user has a busy schedule and finds it difficult to find time for a live tour.

A data storage fee is charged to the client user account for storing data on the back-end system. The data storage fee is applied at a price per data unit rate. In the preferred embodiment of the present invention, the first five hundred megabytes of storage is free and then the data storage fee is two dollars per gigabyte of data stored on the back-end system, however, this is subject to change in other embodiments of the present invention. The data storage fee is also applied to the service provider account for storing any data on the back-end system.

If the streaming event is a tour, then the client user must also pay a tour fee before the event appointment is scheduled, wherein the tour fee is determined by the tour guide. The tour fee can be a fixed rate or a variable rate, such as an hourly rate. An escrow account is provided to hold the designated funds until the tour is completed. The client user pays through the client user account, wherein the tour fee is then transferred from the client user account to the escrow account by the back-end system. In reference to FIG. 10, if the client user has elected to split the cost of the real-time streaming event with other invited guests, then the back-end system sends a payment request to the subsequent user account of each of the invited guests. However, the payment request is sent to the subsequent user account only if the event attendance response if for attending the real-time streaming event. If the invited guest declines the event invitation, then the payment request is not sent to the subsequent user account. The payment request defines the amount of money the client user would like the invited guest to contribute, wherein the invited guest can transfer funds from the subsequent user account to the escrow account.

Upon completing the tour, the client user can allow the release of funds from the escrow account by selecting to release the funds (e.g. clicking a release funds button) through the client user account. Once the selection to release the funds has been made through the client user account, the back-end system transfers the tour fee from the escrow account to the streaming account. After the funds are released, both parties are able to rate one another, wherein the back-end system receives a first rating for the streaming account through the client user account and a second rating for the user account through the streaming account. The first rating and the second rating may be on a number scale, star scale, etc. Additionally, the first rating and the second rating may include written comments.

In another embodiment of the present invention, the funds are released after each party rates each other, wherein a satisfaction threshold is programmed into the back-end system in order to delegate how funds are transferred once the first rating and the second rating are received. For example, if the rating scale is one to five, then the satisfaction threshold could be three and a half, wherein anything above the satisfaction threshold constitutes a good rating and anything below constitutes a bad rating. If the first rating is above the satisfaction threshold, indicating the client user was happy with their experience, the back-end system transfers the tour fee from the escrow account to the streaming account. If the first rating is below the satisfaction threshold, indicating the client user was unhappy with their experience, then an arbitration account is introduced.

The arbitration account is operated by an arbiter of the present invention, and is used to dispute claims from the client user and the tour guide. The arbiter acts as a neutral and objective party that will listen to both the client user and the tour guide. The client user is able to submit a first argument through the client user account, while the tour guide is able to submit a second argument through the streaming account. The first argument and the second argument are received by the back-end system and relayed to the arbitration account, wherein the arbiter can review both cases. The arbiter then makes an arbitration decision based on the first argument and the second argument, wherein the back-end system receives the arbitration decision through the arbitration account and distributes the funds accordingly.

If the arbitration decision is in favor of the second argument, indicating that the arbiter has sided with the tour guide, the back-end system transfers the tour fee from the escrow account to the streaming account. Additionally, any negative ratings or comments by the client user will be removed. If the arbitration decision is in favor of the first argument, indicating that the arbiter has sided with the client user, the back-end system transfers the tour fee from the escrow account to the client user account. If the arbitration decision is in favor of both the first argument and the second argument, indicating that the arbiter has sided with both the client user and the tour guide, the back-end system transfers a portion of the tour fee from the escrow account to the user account and the streaming account.

The present invention provides a funding page that is accessible by both the client user account and the streaming account. The funding account shows a history of the funds that have been held in and transferred through the escrow account. If the funds are currently being held in escrow, then the status is indicated as so. If the funds in the escrow account have been cleared, then a timestamp is provided for the date and/or time the funds were transferred and the account into which the funds were deposited is also listed.

The review process is used to encourage honorable behavior from all involved parties, lest they receive negative reviews from other users. Since these evaluations are available to all users of the platform, both client users and service-providing entities are encouraged to conduct themselves in a respectful and professional manner. Those who perform or behave poorly may find that no clients wish to hire them (in the case of an unprofessional service-providing entity) or that no tour guides wish to offer tours to them (in the case of poorly behaved clients).

It is also a possible for the client user to extend the duration of a tour if it is agreed upon by the tour guide. If the tour guide agrees to extend the virtual tour, then the client user proceeds to pay an additional fee, which is transferred to the escrow account or directly to the streaming account. The additional fee may be at the same rate as the tour guide fee initially paid by the client user, or may be adjusted for overtime pay. For example, the additional fee may be charged at a rate of one and a half or two times as much as the tour guide fee originally paid. The rate of the additional fee may be adjusted at the discretion of the tour guide or an administrator of the present invention, wherein the client user should be notified of the rate prior to extending the duration of the virtual tour.

The present invention provides an accounts page that is accessible through the client user account, wherein the accounts page allows the client user to manage the funds of the client user. The client user can transfer additional funds into the client user account through the accounts page, or use existing funds to increase the amount storage space available or increase the number of streaming minutes available. The back-end system records the existing funds as a credit to the client user account, wherein funds are written off and the credit is reduced as the client user applies the credit to increased storage space or an increased number of streaming minutes.

The client user also has the opportunity to become a tour guide by going through a vetting process. To initiate the vetting process, the client user contacts a quality control member of the present invention and schedules a virtual tour time. At the scheduled virtual tour time, the client user account is communicably connected to a quality control account through the back-end system, wherein the quality control account is operated by the quality control member. The back-end system receives the live stream video feed through the client user account and then displays the live stream video feed through the quality control account. The tour is provided for the quality control member in real-time, allowing the quality control member to evaluate whether or not the client user has sufficient talent and resource (e.g. video recording equipment) for providing virtual tours to paying customers.

Upon completion of the tour by the client user, the quality control member determines a quality control rating for the client user. The quality control rating can be based on a number of categories rated by the quality control member, such as fluency, equipment quality, transmission quality, network quality, oratory skills, accuracy of knowledge, and attitude. A quality control threshold is programmed into the back-end system in order to determine whether or not the client user meets a minimum total rating. The back-end system receives the quality control rating through the quality control account, and if the quality control rating is above the quality control threshold, then the back-end system designates the client user account as a service provider account.

The present invention also provides social networking capabilities, wherein the client user can add friends and share information both publicly and privately. Through the client user account, the client user can upload personal information and media files, such as photos or videos. When a media file is uploaded by the client user, the media file is received by the back-end system through the client user account, wherein the media file is stored on the back-end system in association with the client user account. Once the media file is uploaded, the client user can elect which of the other users of the present invention are able to view the media file. In the preferred embodiment of the present invention, a friends page and a family page are provided in order to organize the contacts of the client user; it is also possible for sub groups to be made within the provided pages.

Additionally, an interactive map is provided for the client user through the client user account. Using the interactive map, the client user can tag different locations around the world. The client user can tag in categories, such as their current location, locations they have virtually travelled to, locations they have physically traveled to, and locations that they would like to travel to in the future. Each different category is tagged in a different color in order easily visualize and distinguish the locations on the interactive map. It may also be a feature to share the interactive map with subsequent client users.

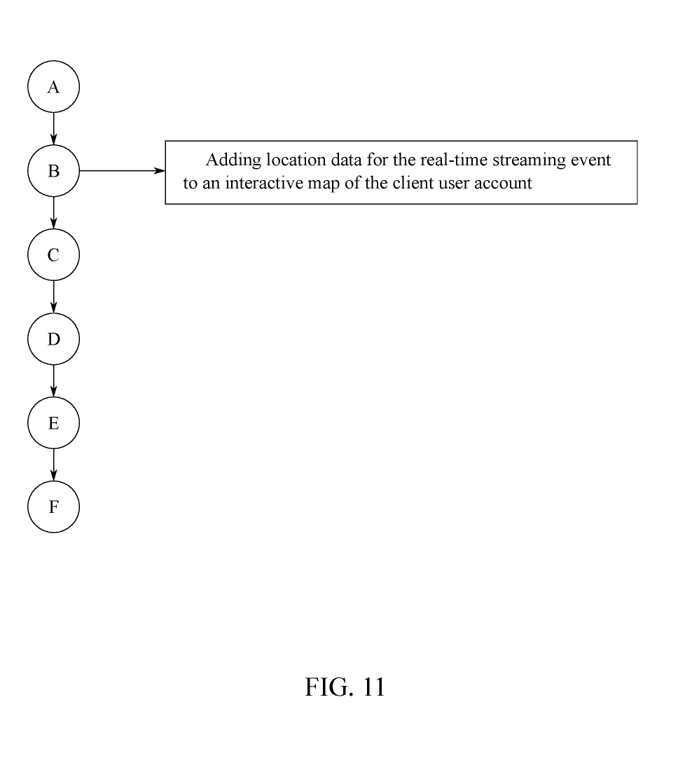

In reference to FIG. 11, the interactive map of the client user account can be automatically updated when the tour information for the tour request or the desired location is received by the back-end system. The back-end system extracts location data for the real-time streaming event from the tour information. The location data for the real-time streaming event is then added to the interactive map in the appropriate tagged color. Furthermore, after the real-time streaming event has taken place, the back-end system can automatically update the color of the tag for the location data of the real-time streaming event, in order to indicate that the client user has virtually traveled to the location.

In addition to adding friends and family to share information with, the client user can choose to subscribe to service-providing entities. In this way, the client user can select a service-providing entity, such as a business or tour guide, to follow and receive updates from the service-providing entity. For example, a tour guide could distribute a list of planned tours to his to her followers, allowing the followers to automatically see upcoming tours and easily select tours to stream; any updates to the tour schedule or relevant notifications made by the tour guide would then also be automatically distributed to followers. The ability to subscribe to service-providing entities not only benefits the client user by receiving automatic updates, but is also beneficial to the service-providing entity as it allows the service providing entity to contact and update a lager client user base at one time.

Incentives may also be provided by the administrator of the present invention in order to encourage increased use of the present invention by both the client users and the service-providing entities. One such example is a rewards system for the client users and a rewards system for the service-providing entities. For example, the client user who has taken the most virtual tours over a defined period of time could be named an e-Hopper extraordinaire and maybe given credit for a free tour, free streaming, free storage etc. An example of a rewards system for the service-providing entities would be to give the tour guide who receives the highest rating for a defined period of time accolades such as promoted viewing/premium advertisement, credit for free streaming, reduced rate streaming, etc.

Beyond the core method and supporting processes, the present invention introduces additional beneficial concepts. The first is a live customer support system, using video conferencing software (as used for providing the virtual tours themselves) to connect users with customer support representatives. This live audio-visual service improves the effectiveness of customer service compared to traditional methods utilizing calls, text chat, frequently asked questions, and non-interactive video tutorials.

The present invention is also constructed to be adaptable to differences in laws across the countries of the world. To accommodate countries which restrict or prohibit certain types of communications and visual material, the present invention will disable social media settings, videos, political discussions and relevant posts, supporting only the live streaming aspect. These restrictions can be applied in a number of different methods. One example is the use of internet protocol (IP) address filtering, which blocks certain features from being accessed by IP addresses originating in a country that restricts or prohibits certain actions. Alternatively, differences in laws can be addressed by providing separate websites as necessary to comply with the laws of different countries.

Although the invention has been explained in relation to its preferred embodiment, it is to be understood that many other possible modifications and variations can be made without departing from the spirit and scope of the invention as hereinafter claimed.

What is claimed is:

1. A method for facilitating live stream feeds of remote locations by executing computer-executable instructions stored on a non-transitory computer-readable medium, the method comprises the steps of:
providing a first electronic streaming device and a second electronic streaming device, wherein a client user account is accessed on the first electronic streaming device and a streaming account is accessed on the second electronic streaming device;
receiving tour information for a real-time streaming event through the client user account;
scheduling, for the real-time streaming event, an event appointment between the streaming account and the client user account;
communicably connecting the client user account to the streaming account through the first electronic streaming device and the second electronic streaming device;
recording a connection duration for which the client user account is communicably connected to the streaming account through the first electronic streaming device and the second electronic streaming device; and
applying a data rate charge according to the connection duration.

2. The method for facilitating live stream feeds of remote locations by executing computer-executable instructions stored on a non-transitory computer-readable medium, the method as claimed in claim 1 further comprises the steps of:
storing the tour information in a repository as a tour request for the real-time streaming event; and
receiving, from each of a plurality of streaming accounts, a guide application to host the real-time streaming event.

3. The method for facilitating live stream feeds of remote locations by executing computer-executable instructions stored on a non-transitory computer-readable medium, the method as claimed in claim 2 further comprises the steps of:
displaying, through the client user account, the guide application for each of the plurality of streaming accounts; and
receiving, from the client user account, an account selection for choosing the streaming account from the plurality of streaming accounts.

4. The method for facilitating live stream feeds of remote locations by executing computer-executable instructions stored on a non-transitory computer-readable medium, the method as claimed in claim 2 further comprises the steps of:
displaying, through the client user account, the tour request in a tour requests list.

5. The method for facilitating live stream feeds of remote locations by executing computer-executable instructions stored on a non-transitory computer-readable medium, the method as claimed in claim 4, wherein the tour request list is filterable through a tour requests module.

6. The method for facilitating live stream feeds of remote locations by executing computer-executable instructions stored on a non-transitory computer-readable medium, the method as claimed in claim 4, wherein the tour request is sortable through a tour requests module.

7. The method for facilitating live stream feeds of remote locations by executing computer-executable instructions stored on a non-transitory computer-readable medium, the method as claimed in claim 2 further comprises the steps of:
displaying the tour request in an applied tours list for each of the plurality of streaming accounts.

8. The method for facilitating live stream feeds of remote locations by executing computer-executable instructions stored on a non-transitory computer-readable medium, the method as claimed in claim 1 further comprises the steps of:
storing the tour information in a repository as a desired location for the real-time streaming event; and
adding the desired location to a destination wish list.

9. The method for facilitating live stream feeds of remote locations by executing computer-executable instructions stored on a non-transitory computer-readable medium, the method as claimed in claim 8 further comprises the steps of:
displaying, through the client user account, a plurality of streaming accounts for the desired location; and
receiving, from the client user account, an account selection for choosing the streaming account from the plurality of streaming accounts.

10. The method for facilitating live stream feeds of remote locations by executing computer-executable instructions stored on a non-transitory computer-readable medium, the method as claimed in claim 1 further comprises the steps of:
receiving, from the client user account, guide information in order to discover a plurality of streaming accounts;
displaying, through the client user account, the plurality of streaming accounts; and
receiving, from the client user account, an account selection for choosing the streaming account from the plurality of streaming accounts.

11. The method for facilitating live stream feeds of remote locations by executing computer-executable instructions stored on a non-transitory computer-readable medium, the method as claimed in claim 1 further comprises the steps of:
providing a profile link for the streaming account, wherein the profile link is displayed on a third-party website; and
receiving an account selection for the streaming account through the profile link.

12. The method for facilitating live stream feeds of remote locations by executing computer-executable instructions stored on a non-transitory computer-readable medium, the method as claimed in claim 1, wherein the tour information is received through a request a tour module.

13. The method for facilitating live stream feeds of remote locations by executing computer-executable instructions stored on a non-transitory computer-readable medium, the method as claimed in claim 1 further comprises the steps of:
adding the event appointment to an events calendar.

14. The method for facilitating live stream feeds of remote locations by executing computer-executable instructions stored on a non-transitory computer-readable medium, the method as claimed in claim 1 further comprises the steps of:
generating an events page for the real-time streaming event; and
displaying event information for the real-time streaming event on the events page.

15. The method for facilitating live stream feeds of remote locations by executing computer-executable instructions stored on a non-transitory computer-readable medium, the method as claimed in claim 14 further comprises the steps of:
sending an event invitation for the real-time streaming event to a subsequent user account;
receiving an event attendance response from the subsequent user account; and
displaying the event attendance response on the events page.

16. The method for facilitating live stream feeds of remote locations by executing computer-executable instructions stored on a non-transitory computer-readable medium, the method as claimed in claim 1 further comprises the steps of:
adding location data for the real-time streaming event to an interactive map of the client user account.

17. The method for facilitating live stream feeds of remote locations by executing computer-executable instructions stored on a non-transitory computer-readable medium, the method as claimed in claim 1 further comprises the steps of:
displaying an upcoming streaming event on a profile page of the streaming account; and
receiving, through the client user account, an event selection for the upcoming streaming event.

18. The method for facilitating live stream feeds of remote locations by executing computer-executable instructions stored on a non-transitory computer-readable medium, the method as claimed in claim 1 further comprises the steps of:
displaying a plurality of showcase listings on a profile page of the streaming account; and
receiving, from the client user account, a showcase selection for a showcase item from the plurality of showcase listings.

19. The method for facilitating live stream feeds of remote locations by executing computer-executable instructions stored on a non-transitory computer-readable medium, the method as claimed in claim 15 further comprises the steps of:
sending a payment request to the subsequent user account, if the event attendance response is for attending the real-time streaming event.
